(19) United States
(12) Patent Application Publication
(10) Pub. No.: US 2008/0017696 A1
(43) Pub. Date: Jan. 24, 2008

(54) Method For Connecting Joining Parts By Hard-Soldering Or Welding, And An Insert For Use In Carrying Out Said Method

(75) Inventors: Werner Urech, Kaiserstuhl (CH); Adrian Sutter, Ettenhausen (CH)

Correspondence Address: MCCORMICK, PAULDING & HUBER LLP, CITY PLACE II, 185 ASYLUM STREET, HARTFORD, CT, 06103, US

(73) Assignee: Soutec Soudronic AG, Neftenbach (CH)

(21) Appl. No.: 11/628,189

(22) PCT Filed: Jun. 1, 2005
(86) PCT No.: PCT/CH05/00306

§ 371 Date: Jan. 29, 2007

(30) Foreign Application Priority Data
Jun. 4, 2004 (CH) 950/04

(51) Int. Cl. B23K 33/00; B23K 31/02; B23K 35/14

(52) U.S. Cl. 228/256; 219/121.46; 219/121.64; 219/600; 228/56.3

(57) ABSTRACT

In the case of the hard-soldering or the welding of joint parts (1,2) which form a notch shaped joint (3), an insert (4) is introduced and soldered or welded in place. As a result, a joint closure is obtained which can be coated without subsequent processing.

The invention concerns a method for the connecting together of metallic joint parts by way of hard-soldering or welding. The invention further concerns an insert for use in the carrying out of the method.

The connection of metallic parts (joint parts) by hard-soldering or by welding is known. In the fabrication of automobile bodies, for example, side pieces and roof pieces of automobile bodies are connected with one another by hard-soldering, in which case the solder should also fill or close the notch between the parts and should form an outer surface which can be primed or painted without subsequent processing, so that no measures for the concealing of the joint are met with, as is the case with a resistance welded or a laser welded connection, especially in the further case of the involved parts having an overlapped arrangement. Especially in this application, but also in the case of other hard-soldered connections, value is laid on an as-much-as-possible pore free outer surface of the hardened solder which fills the joint as well as on an as-uniform-as-possible filling height, even in the case of varying joint widths and thereby changing amounts of solder. WO 02/064300 shows soldering with a burner and with a pre-warming of the solder wire. In practice it is further known to heat the joint parts to be soldered by a laser and to likewise introduce the solder wire to the laser beam so that the laser beam melts the solder wire. Especially in the case of zink coated sheets, the coating of which beyond the joint should be kept intact as much as possible (the vaporization temperature of this zink being about 1060° C.) and with the use of a CuSi-solder or a CuZn-solder with a melting point of about 900-1060° C. a faultless and pore free outer surface of the hardened solder is achieved only with low welding speeds of about 2-3 m/min. If instead of making a hard-soldered connection, a welded connection is made on metal sheets arranged in overlapped condition, for example, by spot welding or by a continuous or interrupted laser welding, subsequent measures must be taken to conceal the welding, for example, by using a subsequently applied shaped plastic piece, or by way of expensive post-processing measures.

The basic object of the invention is to provide an improved hard-solder connection or welded connection which with a high speed of the connecting process has closed or filled joints of good quality, which joints are therefore usable with and especially can be painted over without, or with minimal, subsequent processing. This object is solved by the features of claim 1.

Accordingly, insofar as an insert is arranged in the joint and is connected with the two joint parts a number of advantages are achieved:

The inserted and welded or soldered insert reduces the necessary amount of welding material or solder for the filling of the joint. The outer surface of the closed joint in the longitudinal direction is seen to be very smooth. The sinking or drawing in of the solder or welding material into the base of the joint is hindered and the width of the connecting surface is defined. The amount of the required (expensive) solder is reduced. In comparison to welding or soldering without an insert, the danger of producing pores is strongly reduced. It has further been shown that a high connecting speed of greater than 4 m/min and especially of 5-8 m/min can be achieved. Despite the high speed there results a reliable connection in a form of a uniform, smooth concave remaining joint without open pores.

Preferably the insert is a shaped insert, whose cross sectional shape is non-circular and matches the shape of the joint, such cross sectional shape especially being of generally triangular form.

Possible heat sources to be used for the hard-soldered connection or for the welding connection are, for example, lasers, for example, Nd:YAG diode lasers, fiber lasers, and of single beam or double beam or multiple beam construction, plasma sources, inductive heating, flame, and combination (hybrid) sources.

The method of the invention is usable preferably in the fabrication of vehicle bodies, especially for the connecting of sheet, tubular, profiled and massive parts, which are located in visible or nonvisible areas of the vehicle and are to be painted over without further processing; the method is also usable in raw construction for the connection of sheet parts and especially for the connection of sheet parts with tubular parts.

As the joint parts, for example, two parts with bent flanges can be provided, or one part can be a flat or rounded part and the other part can be a part with a bent flange, so that when the two parts are positioned together a notch is formed.

The insert or the shaped insert can be a wire shaped metal insert, for example of steel, which has a round or an essentially triangularly shaped cross section. Such shaped inserts can for example be created from round wire through the use of shaping rolls. The insert or the shaped insert then after its insertion into the joint is there welded in place, for example through the use of a laser welding apparatus using, for example, two laser beams. For the alternate case of hard-soldering instead of welding the shaped insert is soldered in place with the feeding of a soldering material or a soldering wire in a way known in itself. It is preferred in this case that the insert or the shaped insert have a coating, which partially or completely surrounds it. The coating and surrounding with solder is in this case provided with a thickness which is so chosen that during the hard-soldering procedure no supplementary solder need be delivered. The amount of solder on the insert or shaped insert can however be so chosen that during the hard-soldering procedure additional solder can be applied.

In the following, exemplary embodiments of the invention are explained in more detail with reference to the drawings. In the drawings:

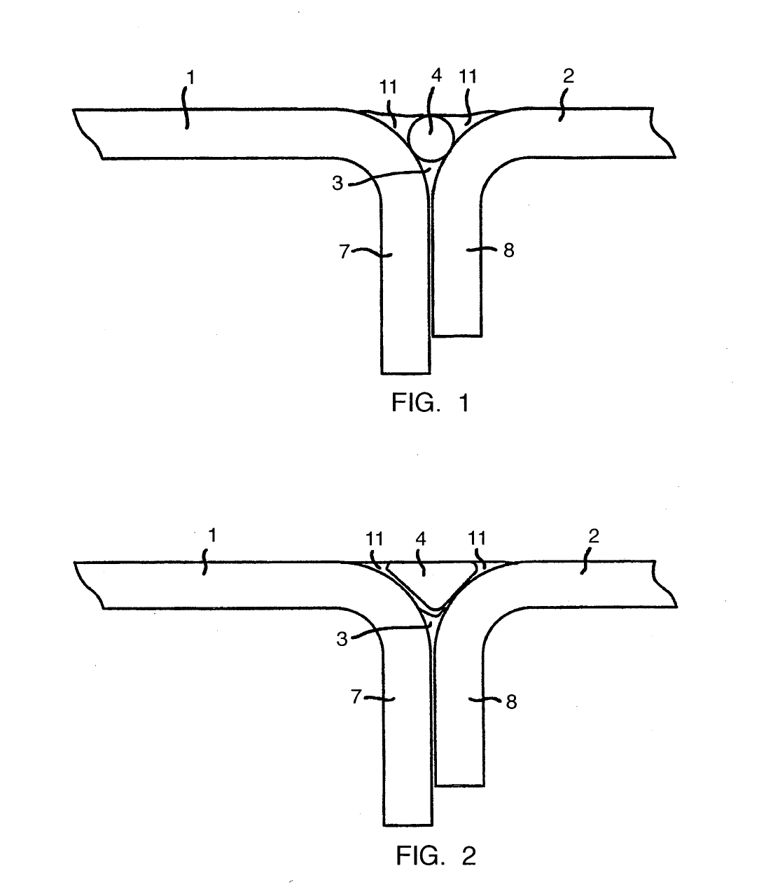

FIG. 1 shows an example of a hard-soldered connection in keeping with the invention;

FIG. 2 shows a further example of such a connection;

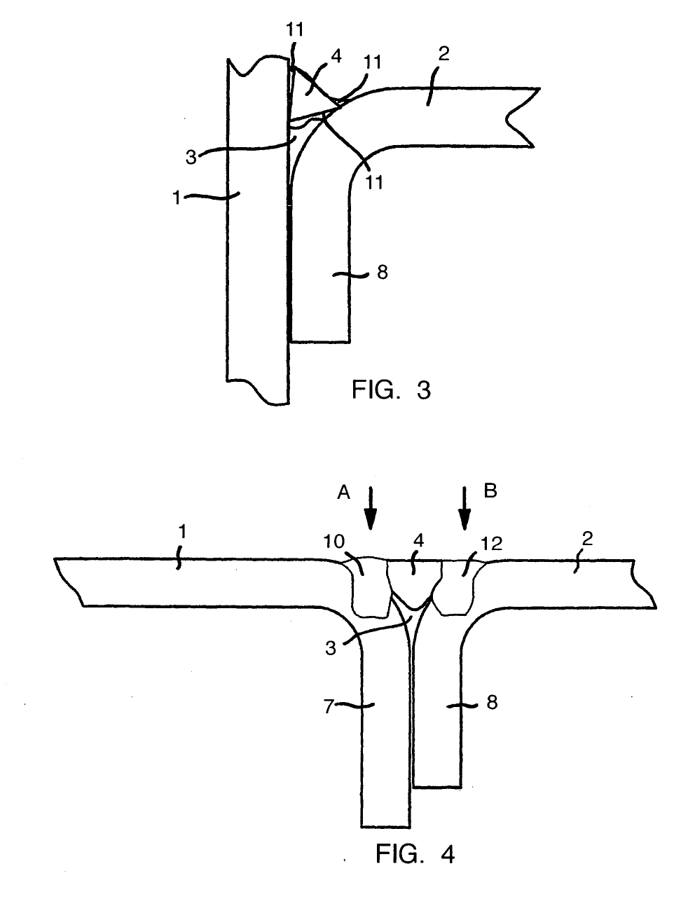

FIG. 3 shows a still further example of such connection;

FIG. 4 shows an example of a welded connection in keeping with the invention;

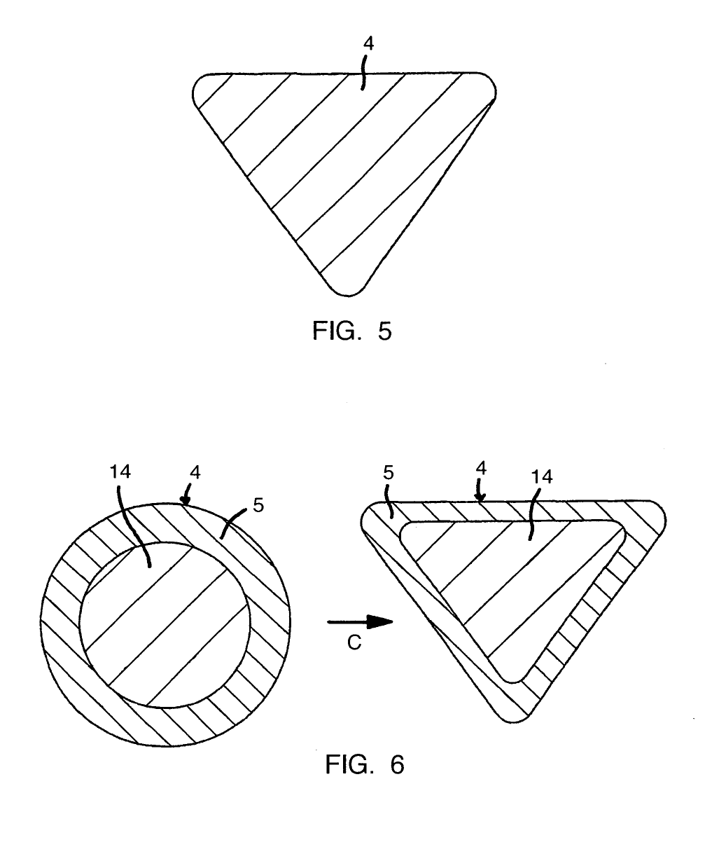

FIG. 5 shows a shaped insert; and

FIG. 6 shows an insert and a shaped insert each with a jacket of hard solder.

FIG. 1 shows schematically the connecting region between one joint part 1 and a second joint part 2. The joint parts are so positioned relative to one another that they produce an essentially notch shaped or V-shaped joint 3 between the joint parts 1 and 2. For this the joint parts 1 and 2 can be provided with bent flange parts 7 and 8, which by being positioned in engagement with one another position the joint parts for their fastening to one another to make the corresponding notch shaped joint. FIG. 1 and also the following FIGS. 2-4 each show a view in which the joint runs perpendicular to the plane of the drawing and the connecting area is illustrated in cross section, but without cross-hatching. Such a joint can naturally also exist between parts of other shapes, so that for example one of the parts can be a tube shaped part, or both of the joint parts can be tube-shaped parts, and also one of the joint parts can be a straight running part, shown for example in FIG. 3. The joint parts 1 and 2 can optionally be metallic parts, which are connectable by hard-soldering or welding. A preferred application area of the present invention lies however in the construction of vehicle bodies so that the joint parts are for example a roof part and a side part of an automobile body, especially made of zink coated steel sheets.

Now, according to the invention, before the hard-soldering or the welding, or perhaps otherwise during the hard-soldering or the welding, an insert 4 is inserted into the joint 3, which insert at least partially fills up the notch. FIG. 1 shows a first example in which the wire shaped insert 4 has a circular cross section and by means of the solder 11 is connected both with the joint part 1 and also with the joint part 2 by the hard-soldering. With this the joint parts 1 and 2 are also connected with one another. The solder 11 can also be directly effective between the joint parts 1 and 2 insofar as the solder partially or entirely also fills the remaining hollow space of the joint 3. The two joint parts 1 and 2 can also be connected with one another by means of further connecting means, such as for example, by supplemental spot welding on the flanges 7 and 8. In the soldering process, the used hard solder 11 can in the form of a solder wire and in a customary way be fed to and melted by a heat source, so that it wets and connects the parts 1 and 2, as well as the part 4, which are heated to the soldering temperature. As the heat source for the soldering all kinds of heat sources come into question, especially however heat sources which are formed by one or more laser beams, as is basically known in the case of hard-soldering.

FIG. 2 shows a further hard solder connection similar to that of FIG. 1, wherein the same reference numbers again indicate basically the same parts. The insert 4 in this case is a shaped insert 4 having a shape suited to the notch shaped joint 3. In the case of the notch-like shape of the joint 3, the insert 4 has a nearly triangular cross section. This is again soldered into the joint by means of hard solder 11. The hard solder can again be fed in the customary way in wire form. Preferred in this case is an embodiment of the insert according to FIG. 6 wherein the insert 4 has a center or core made of a metal which does not melt at the soldering temperature, for example, steel and also has a jacket 5 of solder at least partially surrounding this core. In this case, the insert 4 can be inserted into the notch 3 and thereafter the soldering can take place by moving the heat source relative to the notch without further solder having to be supplied in the form of a solder wire or in some other way. Such addition of further solder, however, can take place as a supplement to the solder jacket insert. Since with the solder jacket insert 4 meltable solder is provided simultaneously along the entire joint, the heating effect can also take place simultaneously over large joint sections or along the entire joint, so that the soldering does not, as known, take place by advancing successively along the joint, but instead all at one time along joint sections or along the entire joint.

FIG. 3 shows a further embodiment wherein again the same reference numbers indicate the same elements. In this case, the joint part 1 in the region of the joint is a straight running or planer part without a bent flange. The insert 4 is again a shaped insert.

FIG. 4 shows the alternative procedure in which welding is used in place of the hard-soldering. Again two joint parts 1 and 2 are illustrated which between themselves form the joint 3. Again in the joint an insert 4 is inserted, which can be a wire like insert with a round cross section or can also be a shaped insert 4. In the illustrated case a shaped insert is used. This consists of a metal material with welding properties similar to those of the joint parts 1 and 2 so that through the use of a welding heat source, a welding of the insert 4 to the joint parts 1 and 2 can be achieved. In the illustrated example two welding beams A and B are illustrated by arrows, which it will be understood in the welding process and in corresponding ways effect the welding regions 10 and 12 so as to bring about the welding of the parts 1 and 2 and 4. The welding beams A and B can for example be two laser beams, which by means of a beam splitter are derived from a laser source. Also the welding beams are moved appropriately relative to the joint, either by movement of the laser beam-emitting opening over the stationary parts 1 and 2 and 4 or by movement of the parts 1, 2 and 4 by means of a conveyor arrangement relative to a stationary laser emitting station. This is basically known and not explained in more detail here.

FIG. 5 shows a corresponding shaped insert 4 in cross section, which for example is made of a steel wire. This shaped insert is suitable for welding as well as for hard-soldering with an externally supplied hard-solder. FIG. 6 shows a shaped insert 4 which first has a circular cross section (left in the figure), and which by a process using a shaping rolls, which is only indicated by the arrow C, can be formed to a shaped insert (at the right in the figure). In the case of both of the stages of the insert it is illustrated that it is comprised of a core 14, which does not melt during the hard-soldering and a jacket 5 of hard solder. The jacket 5 can be arranged completely around the core 14 as illustrated or it can also only partly cover the core 14. Also the application of the jacket 5 to the core can take place either before or after the shaping step C. In either event, the jacket 5 can be obtained by the core 14 being drawn one or more times through a bath of liquid solder or it can be formed around the wire core 14 by an extrusion process.

Not shown in the figures is a configuration of the joint parts such that the edge portions to be joined have no bent edge regions and stand perpendicularly to one another, so as to form a T-junction. A shaped wire can in accordance with the invention be inserted into one of the corners (or into both of the corners) and then be welded or soldered with the joint parts. In this way the advantage of the invention concerning surface quality is achieved and moreover the load carrying capacity of the connection is increased by the enlarged connecting surfaces.

1. A method for the connection of metallic joint parts (1, 2) by hard-soldering or welding characterized in that the joint parts are positioned relative to one another to form an essentially notch shaped joint (3), and that a wire like insert (4), which at least partially fills the joint, is connected in the joint by hard-soldering or welding with both joint parts.

2. A method according to claim 1, further characterized in that the insert has a round cross section.

3. A method according to claim 1, further characterized in that the insert is provided as a shaped insert and has a non-circular cross section.

4. A method according to claim 3, further characterized in that the shaped insert has a shape fitting the shape of the joint and especially a triangular cross section.

5. A method according to claim 1, further characterized in that in the case of hard-soldering the insert is provided with a partial or complete jacket (5) of solder.

6. A method according to claim 5, further characterized in that the jacket forms the single source of solder or that during the hard-soldering additional solder is supplied.

7. A method according to claim 1, further characterized in that in the case of welding, two heating beams (A, B) are used, which two beams are effective respectively on the two regions at which the insert contacts the joint parts.

8. A method according to claim 1, further characterized in that the two joint parts (1, 2) have bent flanges (7, 8) positioned relative to one another to form the joint.

9. A method according to claim 1, further characterized in that one of the joint parts (2) has a bent flange (8), which is positioned next to a planar or round joint part (1) to form the joint.

10. A method according to claim 1, further characterized in that as a heat source a laser, especially a two beam laser mechanism, and/or a plasma source and/or a heat source inductively heating the insert and the joint parts and/or a flame heat source is used.

11. The application of the method according to claim 1 to the fabrication of automobile bodies, especially for the connection of roof parts with side parts of the body.

12. An insert for use in the carrying out of the method according to claim 1 in the case of hard-soldering, characterized in that the wire like insert has a metallic core (14) and a jacket (5) of hard solder partially or entirely surrounding the core, especially a CuSi-solder or a CuZn-solder.

13. An insert according to claim 12, further characterized in that said insert is a shaped insert (4) with a non-circular cross section.
